(19) United States
(12) Patent Application Publication
(10) Pub. No.: US 2004/0012686 A1
(43) Pub. Date: Jan. 22, 2004

(54) Image capturing apparatus

(75) Inventors: Takeshi Ono, Sakai-Shi (JP); Shinya Nara, Sakai-Shi (JP); Koji Yasuda, Sakai-Shi (JP); Tsutomu Honda, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/603,442

(22) Filed: Jun. 25, 2003

(30) Foreign Application Priority Data
Jul. 4, 2002 (JP) P2002-195855

(51) Int. Cl. H04N 5/232

(52) U.S. Cl. 348/211.99

(57) ABSTRACT

The present invention provides an image capturing apparatus capable of efficiently transmitting image data to an external device and having improved reliability in data transmission. A data communication mode established between a data communication part and an external device is determined by a communication mode determining part. A compression ratio setting part sets a compression ratio adapted to the data communication mode determined by the communication mode determining part and sets the compression ratio to a compressor. The compressor performs a compressing process on image data to be transmitted on the basis of the set compression ratio. The compressed image data is sent to the data communication part and transmitted to the external device. As image data to be transmitted is compressed at a compression ratio adapted to a data communication mode, the amount of the image data to be transmitted is adjusted in accordance with the data communication mode, so that efficient and highly-reliable data transmission is realized.

This application is based on application No. 2002-195855 filed in Japan, the contents of which are hereby incorporated by reference.

### BACKGROUND OF THE INVENTION

1. Field of the Invention

The present invention relates to an image capturing apparatus such as a digital camera.

2. Description of the Background Art

A conventional digital camera photographs a subject, compresses image data by a predetermined compressing method such as JPEG, and records the compressed image data onto a recording medium. At the time of transferring image data to an external device, the compressed image data recorded on the recording medium is transmitted as it is.

Connection modes for connecting an external device to a digital camera include connection modes according to USB and IEEE1394. Further, in recent years, a digital camera having a wired or wireless network communication function and performing data communication with an external device via a network, not direct communication with an external device according to USB, IEEE1394, or the like is also realized. Consequently, in the case of transmitting image data from a digital camera to an external device, image data can be transmitted by selecting one of various communication modes in accordance with circumstances.

In the case where data communication can be performed in a plurality of communication modes in a digital camera, however, transfer speed of image data varies according to a communication mode established between the digital camera and an external device. Consequently, when compressed image data recorded on a recording medium at the time of image capturing is transmitted as it is, time required to complete transmission of image data varies according to the transfer speed. Particularly, in the case of low-speed communication, a problem arises in that time required to transfer image data is long.

A digital camera is often driven by a battery. When time required to transfer image data becomes longer, there is the possibility that the battery is exhausted before completion of transfer of image data recorded on a recording medium. In this case, image data cannot be transferred excellently.

When the communication mode established between a digital camera and an external device is wireless communication such as wireless LAN, stability of data communication is lower than that of wire communication, and a communication error tends to occur. Consequently, when image data of a large capacity is transmitted in the case of wireless communication, transfer time becomes remarkably long due to occurrence of a communication error. In the worst case, there is the possibility that image data cannot be transferred.

### SUMMARY OF THE INVENTION

The present invention is directed to an image capturing apparatus. According to an aspect of the present invention, the image capturing apparatus comprises: an image generator for photographing a subject and generating image data; an interface for performing data communication with an external device; a discriminator for determining a data communication mode established between the interface and the external device; a compressor for setting a compression ratio adapted to the data communication mode on the basis of a result of determination of the discriminator and compressing the image data at the set compression ratio; and a transmitter for transmitting the image data compressed by the compressor to the external device via the interface.

With the configuration, the amount of image data to be transmitted can be adjusted in accordance with a data communication mode. Therefore, image data can be efficiently transmitted to an external device and reliability of data transmission can be improved.

According to another aspect of the present invention, an image capturing apparatus comprises: an image generator for photographing a subject and generating image data; an interface for performing data communication with an external device; a detector for detecting a remaining capacity of a driving source for driving the image capturing apparatus; a compressor for setting a compression ratio on the basis of the remaining capacity of the driving source detected by the detector and compressing the image data at the set compression ratio; and a transmitter for transmitting the image data compressed by the compressor to the external device via the interface.

With the configuration, the amount of image data to be transmitted can be adjusted in accordance with the remaining capacity of a driving source. Therefore, image data can be efficiently transmitted to an external device and reliability of data transmission can be improved. When the remaining capacity of the driving source becomes smaller than a predetermined capacity, by setting the compression ratio to a higher value as compared with the case where the remaining capacity of the driving source is larger than the predetermined capacity, data can be transmitted efficiently also in the case where the remaining capacity of the driving source becomes small. Thus, transmission of image data can be completed excellently and reliability in data transmission is improved.

According to still another aspect of the present invention, an image capturing apparatus comprises: an image generator for photographing a subject and generating image data; a recorder for recording the image data generated by the image generator onto a recording medium; a first detector for detecting an amount of the image data recorded on the recording medium; a second detector for detecting a remaining capacity of a driving source for driving the image capturing apparatus; an interface for performing data communication with an external device; a reader, when the remaining capacity of the driving source detected by the second detector becomes smaller than a predetermined amount, for reading image data from the recording medium in order from image data of a smaller amount on the basis of a result of detection performed by the first detector; and a transmitter for transmitting the image data read by the reader to the external device via the interface.

With the configuration, also in the case where the remaining capacity of the driving source is smaller than the predetermined capacity, a larger amount of image data can be transmitted to an external device, and image data can be transmitted efficiently.

The present invention is also directed to a method of compressing image data captured by an image capturing apparatus. According to an aspect of the present invention, the compressing method comprises the steps of: generating image data; determining a data communication mode established between an interface for performing data communication and an external device; setting a compression ratio adapted to the determined data communication mode; compressing the image data at the set compression ratio; and transmitting the compressed image data to the external device via the interface.

According to another aspect of the present invention, an compressing method comprises the steps of: generating image data; detecting a remaining capacity of a driving source for driving the image capturing apparatus; setting a compression ratio on the basis of the detected remaining capacity of the driving source and compressing the image data at the set compression ratio; and transmitting the compressed image data to an external device via the interface.

Further, the present invention is also directed to a method of transmitting image data captured by an image capturing apparatus. According to an aspect of the present invention, the transmitting method comprises the steps of: generating image data; recording the generated image data onto a recording medium; detecting an amount of the image data recorded on the recording medium; detecting a remaining capacity of a driving source for driving the image capturing apparatus; reading the image data from the recording medium in order from a smaller amount of image data in the detected data amount, when the remaining capacity of the driving source becomes smaller than a predetermined amount; and transmitting the read image data to an external device via an interface.

As described above, an object of the present invention is to provide a technique of enabling transmission of image data to an external device to be efficiently performed in an image capturing apparatus such as a digital camera and of improving reliability of data transmission.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a data transfer system for transferring image data from a digital camera;

FIG. 2 is a diagram showing layout of communication connectors in the digital camera;

FIG. 3 is a block diagram showing the internal configuration of the digital camera;

FIG. 4 is a flowchart showing an image capturing operation in the digital camera;

FIG. 5 is a flowchart showing a basic image transferring operation;

FIG. 6 is a flowchart showing an image transferring operation based on a remaining capacity of a battery;

FIG. 7 is a first flowchart regarding real-time transfer of a moving image to be captured;

FIG. 8 is a second flowchart regarding the real-time transfer of a moving image to be captured;

FIG. 9 is a flowchart showing an image capturing operation including compression performed at the time of image capturing (recording);

FIG. 10 is a flowchart showing an image transferring operation in the case where a compressed image is recorded;

FIG. 11 is a flowchart showing an image transferring operation based on a data amount;

FIG. 12 is a block diagram showing a second internal configuration of the digital camera; and

FIG. 13 is a flowchart showing a second image transferring operation based on a remaining capacity of a battery.

### DESCRIPTION OF THE PREFERRED EMBODIMENTS

Hereinafter, embodiments of the present invention will be described in detail with reference to the drawings.

1. First Embodiment

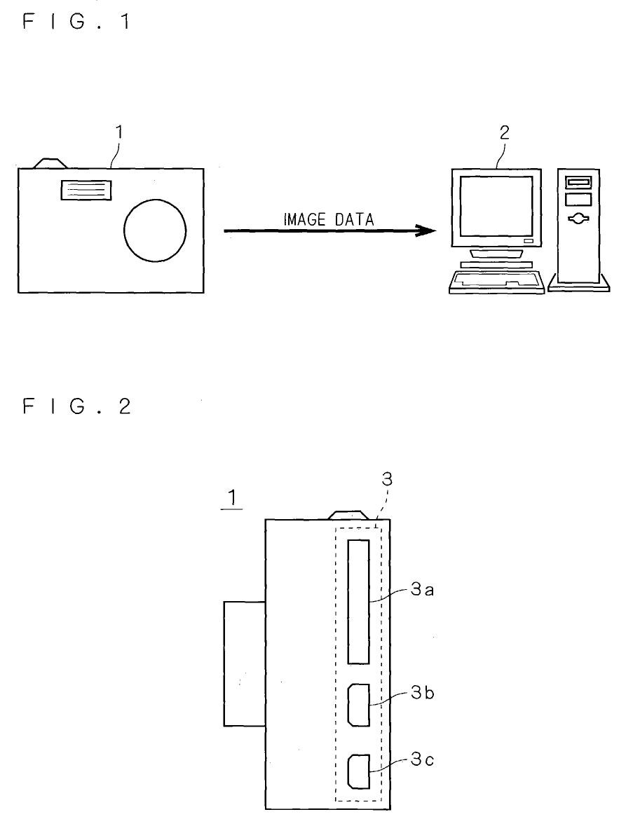

FIG. 1 is a diagram showing a data transfer system for transferring image data from a digital camera 1. The digital camera 1 takes a still image or a moving image and generates electronic image data. The digital camera 1 is constructed so as to be able to transfer the image data generated by the image capturing operation to an external device 2 such as a computer.

The digital camera 1 and the external device 2 as a destination of image data are connected to each other so as to be able to perform data communication in a wire or wireless manner. Image data obtained by the image capturing operation of the digital camera 1 is transmitted from the digital camera 1 to the external device 2 in a state where data communication between the digital camera 1 and the external device 2 is established.

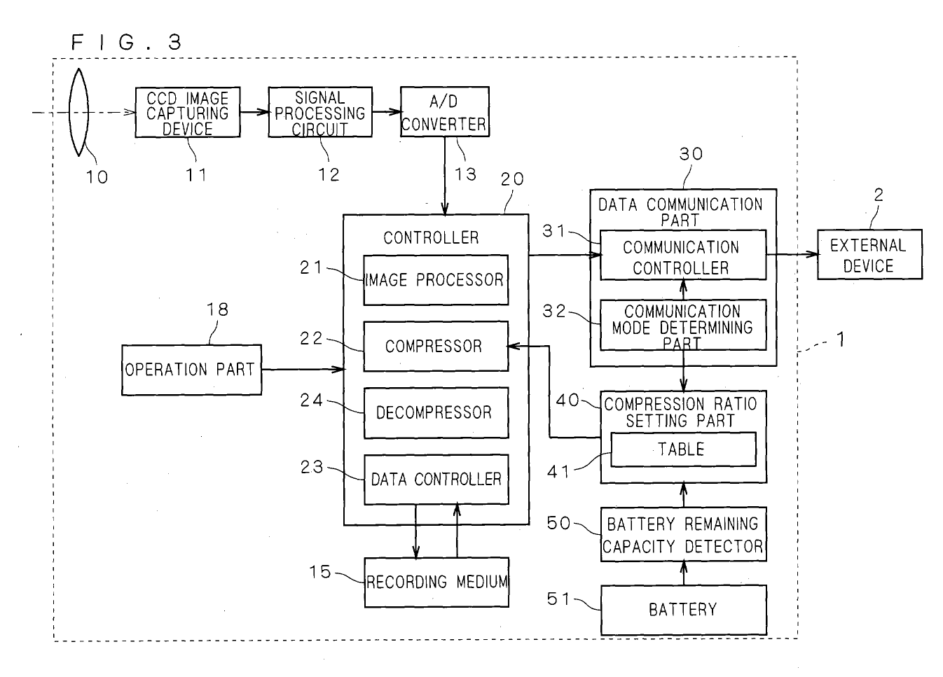

The digital camera 1 can establish a plurality of kinds of data communication modes as data communication modes with the external device 2. FIG. 2 is a diagram showing layout of communication connectors in the digital camera 1. In a side face of the digital camera 1, a connector part 3 is provided. The connector part 3 includes a card connector 3a into which any of various communication cards such as a modem card and an LAN card is inserted, a connector 3b for USB, and a connector 3c for IEEE1394 for directly connecting the external device 2.

For example, when a modem card for connecting a telephone line or an LAN card for wire communication is inserted into the card connector 3a, wire data communication is established between the digital camera 1 and the external device 2. When a wireless communication card of PHS (Personal Handyphone System), Bluetooth, or the like or a wireless LAN card is inserted, wireless data communication is established between the digital camera 1 and the external device 2. Further, when a cable for connecting to the external device 2 is attached to the connector 3b for USB or the connector 3c for IEEE1394, one-to-one direct data communication via the cable is established between the digital camera 1 and the external device 2.

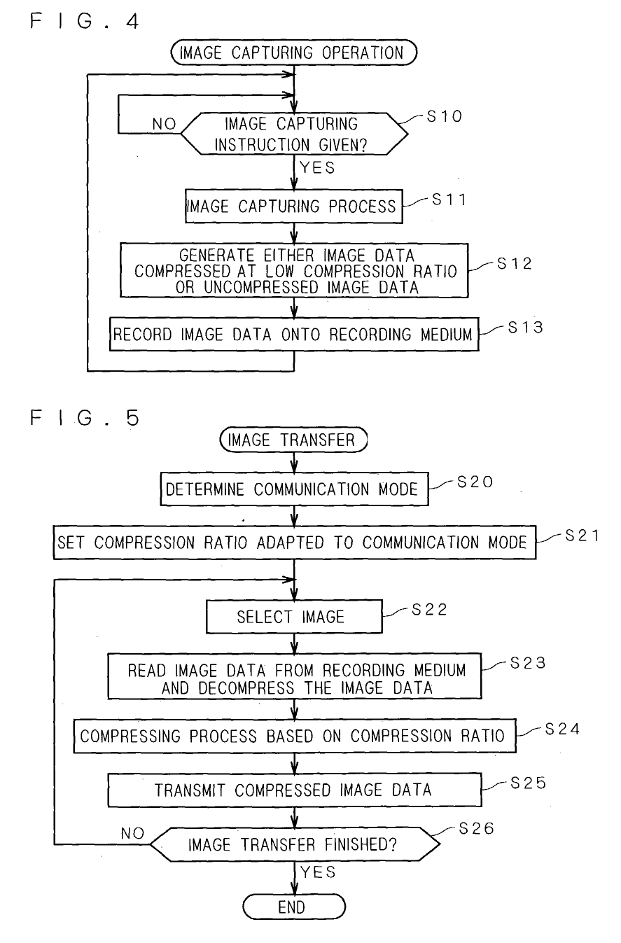

FIG. 3 is a block diagram showing the internal configuration of the digital camera 1. In the digital camera 1, light from the subject entering a taking lens 10 falls on a CCD image capturing device 11 and is photo-electrically converted by the CCD image capturing device 11. As a result, an electronic image signal is generated and supplied to a signal processing circuit 12. The signal processing circuit 12 performs an analog signal process such as gain control on the image signal obtained from the CCD image capturing device 11. The processed image signal is supplied to an A/D converter 13 where the image signal is converted from an analog signal to a digital signal, thereby generating image data of the subject.

When photoelectric conversion in the CCD image capturing device 11 is performed once, image data of a still image is obtained. When photoelectric conversion is continuously repeated, image data of a moving image is obtained.

By such an image capturing operation, the digital camera 1 can generate image data of a subject. When the still image capturing is set, image data of a still image is generated. When the moving image capturing is set, image data of a moving image is generated. Image data obtained by the A/D converter 13 is supplied to a controller 20.

The controller 20 functions as an image processor 21, a compressor 22, a decompressor 24, and a data controller 23 and controls the image capturing operation in the digital camera 1 and data communication with the external device 2 in a centralized manner. A signal from an operation part 18 is also inputted to the controller 20. The controller 20 performs a control operation based on an input operation of the user: For example, when the user sets a still image capturing mode, the controller 20 executes a control for generating image data of a still image in the image capturing operation. When the user sets a moving image capturing mode, the controller 20 executes a control for generating image data of a moving image in the image capturing operation. Except for the modes, the digital camera 1 can set communication modes for transmitting image data to the external device 2. The communication modes include a real-time transmission mode for simultaneously performing the moving image capturing operation and the image data transmitting operation.

The image processor 21 performs various image processes except for compression of image data. For example, a process of adjusting an image size by a reducing process or the like is performed by the image processor 21.

The compressor 22 performs an image compressing process. In the compressing process, the compressor 22 compresses image data at a compression ratio designated by a compression ratio setting part 40. By the compressing process, in the case of a still image, compressed image data in the JPEG format or the like is generated. In the case of a moving image, compressed image data in the MPEG format or the like is generated.

Generally, when the compression ratio is high, although the amount of compressed image data is small, the quality of the image deteriorates. On the contrary, when the compression ratio is low, although the amount of compressed image data is large, the quality of the image improves.

The data controller 23 accesses a recording medium 15 provided in or inserted into the digital camera 1, and performs a process of recording/reading image data to/from the recording medium 15. The recording medium 15 may take the form of a semiconductor memory, a small-size magnetic disk, or the like.

The controller 20 outputs image data subjected to the compressing process in the compressor 22 to a data communication part 30 and can transmit image data to be transmitted to the external device 2 in a compressed state.

The decompressor 24 decompresses the compressed image data recorded on the recording medium 15 to the original image and outputs the decompressed image data to the compressor 22.

The operation part 18 includes a shutter release button used by the user to give an image capturing instruction to the digital camera 1 and other setting switches.

The data communication part 30 is used to perform data communication with the external device 2 and transmits image data supplied from the controller 20 to the external device 2. As described above, the digital camera 1 can establish a plurality of kinds of data communication modes with the external device 2. The data communication part 30 determines the data communication mode established between the data communication part 30 and the external device 2, and performs data communication corresponding to the determined data communication mode.

A communication mode determining part 32 has the function of determining the data communication mode with the external device 2. For example, by detecting the connector in the connector part 3 to which a card or cable is connected, the data communication mode with the external device 2 is determined. Particularly, when a communication card is inserted to the card connector 3a, by determining the kind of the communication card, the data communication mode with the external device 2 is determined.

A communication controller 31 sets transfer speed or the like adapted to the communication mode with the external device 2 on the basis of a result of determination in the communication mode determining part 32 and establishes transmission/reception of data to/from the external device 2.

When the communication mode determining part 32 determines the data communication mode, the data communication speed (transfer speed) between the digital camera 1 and the external device 2, wire communication or wireless communication, and the like are specified.

To detect transfer speed by the communication mode determining part 32, transfer speed determined according to the standard of the data communication mode established with the external device 2 may be detected. In this case, however, the transfer speed may be different from actual transfer speed. Consequently, when the communication mode determining part 32 detects transfer speed, it is desirable to detect transfer speed of actual data transfer. For example, when the digital camera 1 and the external device 2 are connected according to IP (Internet Protocol), by using a “ping” command or the like, the actual transfer speed between the digital camera 1 and the external device 2 can be predicted.

The result of determination of the data communication mode in the communication mode determining part 32 is given to the communication controller 31 and also to the compression ratio setting part 40. The compression ratio setting part 40 determines a compression ratio corresponding to the data communication mode established between the digital camera 1 and the external device 2 and sets the compression ratio to the compressor 22 in the controller 20. The compression ratio setting part 40 has a memory for storing a lookup table 41 and determines the compression ratio adapted to the data communication mode with the external device 2 by referring to the table 41.

The digital camera 1 is provided with a battery 51 for supplying power to the components. In a state where power is not supplied from the outside, by the power supplied from the battery 51 taking the form of a primary or secondary battery, the digital camera 1 can perform the image capturing operation and the data transfer. To the digital camera 1, an AC adapter, an external battery, or the like can be connected. When any of them is connected, by receiving power supplied from an external power source, the image capturing operation and data transfer are performed.

A battery remaining capacity detector 50 detects a remaining capacity (remaining life) of the battery 51 provided in the digital camera 1. When an external battery is connected, the battery remaining capacity detector 50 functions to detect the remaining capacity of the external battery. Concretely, by detecting a supply voltage, an internal resistance value, or the like of the battery 51 or an external battery, the remaining capacity is detected. When the AC adapter is connected, it is unnecessary to detect the battery remaining capacity.

When the remaining capacity of the battery 51 or external battery becomes smaller than a predetermined value, it is found out that operable time of the digital camera 1 becomes relatively short. Consequently, when the battery remaining capacity becomes smaller than the predetermined value, the battery remaining capacity detector 50 supplies a signal indicative of the fact to the compression ratio setting part 40.

When the signal indicating that the battery remaining capacity is small is received from the battery remaining capacity detector 50, the compression ratio setting part 40 changes the setting of the compression ratio of image data determined on the basis of the data communication mode established between the digital camera 1 and the external device 2 to a higher value and instructs the changed compression ratio to the compressor 22.

In the digital camera 1 with such a configuration, at the time of transmitting image data to the external device 2, image data is compressed at a compression ratio which is optimum to the data communication with the external device 2 and the compressed image data is transmitted to the external device 2. Specifically, the compressor 22 performs the compressing process on image data obtained from the recording medium 15 at the compression ratio designated by the compression ratio setting part 40 at the time of transmitting image data, and outputs the compressed image data to the data communication part 30. The communication controller 31 transmits the compressed image data obtained from the compressor 22 to the external device 2. With such a configuration, transmission of image data to the external device 2 can be completed within predetermined time with reliability. Efficiency and reliability of image data transmission can be improved.

The table 41 stored in the compression ratio setting part 40 includes first table data in which the compression ratio at the time of transmitting image data recorded in the recording medium 15 is specified and second table data in which a compression ratio applied to real-time transmission of a moving image for performing simultaneously the image capturing operation and the transmitting operation is specified.

First, as the first table data, the compression ratios are specified as shown in Table 1.

TABLE 1

| Data communication mode | | Transferred speed | Composition ratio |
|---|---|---|---|
| Wire | ISDN | 128 kbps | R3 |
| communication | communication | | |
| | ADSL | 10 Mbps | R2 |
| | communication | | |
| | Optical fiber | 10 Mbps | R2 |
| | communication | | |
| Wireless | Bluetooth/PHS | 1 Mbps | R4 |
| communication | Wireless LAN | 11 Mbps | R3 |
| | | 54 Mbps | R2 |
| Direct | USB | 12 Mbps | R2 |
| communication | | 480 Mbps | R1 |
| | IEEE1394 | 400 Mbps | R1 |

wherein R1 < R2 < R3 < R4

As the second table data, compression ratios are specified as shown in Table 2.

TABLE 2

| | | Transferred | |
|---|---|---|---|
| Data communication mode | | speed | Compression ratio |
| Wire | ISDN | 128 kbps | R4 |
| communication | communication | | |
| | ADSL | 10 Mbps | R3 |
| | communication | | |
| | Optical fiber | 10 Mbps | R2 |
| | communication | | |
| Wireless | Bluetooth/PHS | 1 Mbps | R5 |
| communication | Wireless LAN | 11 Mbps | R4 |
| | | 54 Mbps | R3 |
| Direct | USB | 12 Mbps | R2 |
| communication | | 480 Mbps | R1 |
| | IEEE1394 | 400 Mbps | R1 |

wherein R1 < R2 < R3 < R4 < R5

As shown in Tables 1 and 2, in the compressing process performed on image data to be transmitted, the higher the transfer speed of the data communication mode is, the lower the compression ratio is. On the contrary, the lower the transfer speed of the data communication mode is, the higher the compression ratio is. That is, the lower the transfer speed is, image data is compressed at a higher compression ratio, thereby reducing the amount of image data to be transmitted. It enables efficient data transmission, so that the process of transmitting image data is completed within predetermined time. The higher the transfer speed is, image data is compressed at a lower compression ratio, thereby transmitting high-quality image data.

As shown in Tables 1 and 2, in the case of wireless communication, even when the transfer speed is about the same as that in wire communication, a compression ratio higher than that in the wire communication is set for the following reason. In wireless communication, stability of data communication is low. Consequently, by further reducing the amount of image data to be transmitted, the possibility of normally completing transmission of image data is increased. Therefore, when the communication mode determining part 32 determines wire communication or wireless communication and, in the case of wireless communication, a compression ratio higher than that in wire communication is set, thereby enabling reliability of data communication to be further improved.

Further, as shown in Table 2, in the case of performing real-time transmission of a moving image, except for direct communication according to USB, IEEE1394 or the like, a compression ratio higher than that in the case of transmitting image data temporarily recorded in the recording medium 15 (Table 1) is set. As described above, in the case of the real-time transmission of a moving image, by setting a relatively high compression ratio, occurrence of a delay in the digital camera 1 is prevented excellently and the image capturing operation and the transmitting operation can be performed concurrently. When a delay does not occur in the digital camera 1 even when a compression ratio similar to that in Table 1 is applied at the time of real-time transmission of a moving image, the compression ratio in Table 1 may be applied.

When a signal indicating that the battery remaining capacity is smaller than the predetermined value is received, the compression ratio setting part 40 changes the compression ratio obtained from the table 41 which is Table 1 or 2 to a value which is, for example, higher by one level and instructs the changed compression ratio to the compressor 22. In such a manner, the amount of image data to be transmitted is reduced so that the image data transmitting process is completed excellently even in a situation where the battery remaining capacity is small.

A concrete operation of the digital camera 1 will be described below.

First, the operation of temporarily recording image data obtained by a still image capturing operation onto the recording medium 15 and transmitting the image data recorded on the recording medium 15 to the external device 2 will be described.

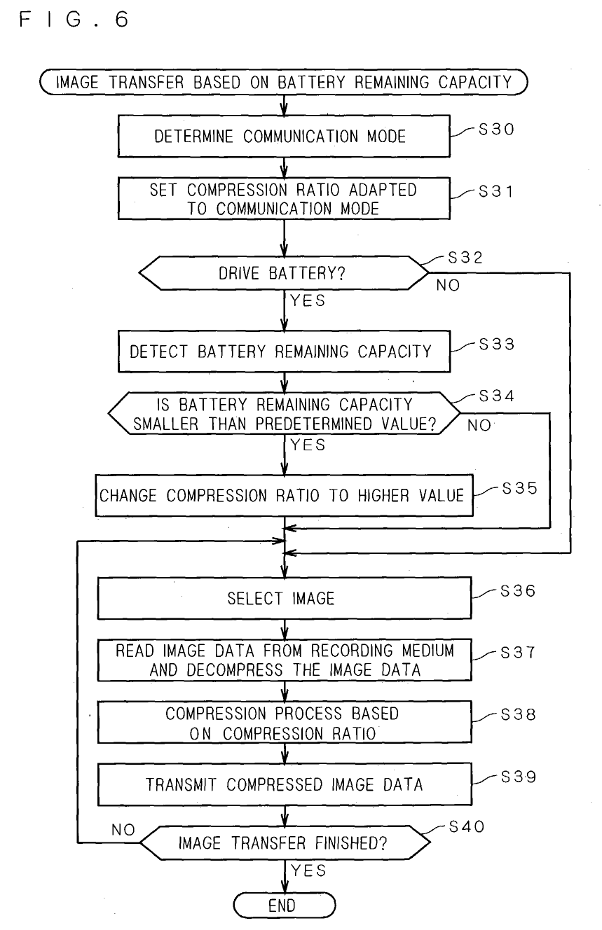

FIG. 4 is a flowchart showing the image capturing operation in the digital camera 1. The controller 20 detects whether the shutter release button has been pressed by the user or not, thereby determining whether the image capturing instruction is given or not (step S10). When an image capturing instruction is given, the image capturing process is started (step S11). Specifically, photoelectric conversion in the CCD image capturing device 11, signal process in the signal processing circuit 12, and A/D conversion in the A/D converter 13 are performed as a series of image capturing processes. Image data obtained from the A/D converter 13 is supplied to the controller 20, and image data which is either compressed at a low compression ratio or uncompressed is generated (step S12) and stored onto the recording medium 15 (step S13).

By the operation, high-precision image data of a relatively large amount is recorded on the recording medium 15. Further, when the image capturing instruction is given, the image capturing operations in steps S10 to S13 are repeated, and image data obtained by the image capturing operation is sequentially recorded on the recording medium 15.

FIG. 5 is a flowchart showing a basic image transferring operation performed at the time of transmitting image data recorded on the recording medium 15 to the external device 2. First, to perform data communication between the digital camera 1 and the external device 2, the user preliminarily performs an operation of connecting a cable or card to any of the connectors in the connector part 3. When image transfer is instructed in the digital camera 1, the data communication part 30 performs the process of determining the data communication mode (step S20), and the compression ratio setting part 40 sets the compression ratio corresponding to the data communication mode to the compressor 22 (step S21).

The data controller 23 in the controller 20 selects one piece of image data to be transmitted from a group of image data pieces recorded on the recording medium 15 (step S22) and reads the selected image data from the recording medium 15. In the case where the read image is compressed, the decompressor 24 decompresses the compressed image to the original image (step S23). The image data read from the recording medium 15 and decompressed is supplied from the data controller 23 to the compressor 22 and is subjected to the compressing process at the compression ratio which is set on the basis of the data communication mode in the compressor 22 (step S24). The image data compressed in the compressor 22 is supplied to the data communication part 30 and transmitted to the external device 2 (step S25).

For example, when data communication between the digital camera 1 and the external device 2 is realized by wireless communication according to PHS or Bluetooth, image data compressed at a compression ratio R4 is transmitted to the external device 2 (see Table 1).

Whether transfer of all of image data to be transmitted has been finished or not is determined by the controller 20 (step S26). When image data to be transmitted remains, the processes in steps S22 to S25 are repeated. When all of image data to be transmitted has been transferred, the image transferring process is finished.

By such image transfer, image data is compressed at the compression ratio according to the data communication mode established between the digital camera 1 and the external device 2 at the time of transmitting the image data in the digital camera 1, and the amount of image data to be transmitted can be adjusted according to the data communication mode of wire or wireless communication and the transfer speed. By setting the compression ratio to a high value when the transfer speed is low or to a low value when the transfer speed is high, an optimum data amount according to the data communication mode can be obtained. Thus, irrespective of the transfer speed between the digital camera 1 and the external device 2, image data transmission can be completed within predetermined time.

Particularly, when the data communication mode between the digital camera 1 and the external devise 2 is wireless communication, stability of the data communication is lower as compared with the case of wire communication. Consequently, by further reducing the amount of image data to be transmitted, the possibility of completing transmission of image data before the data communication is interrupted can be increased, so that more reliable transfer process is realized.

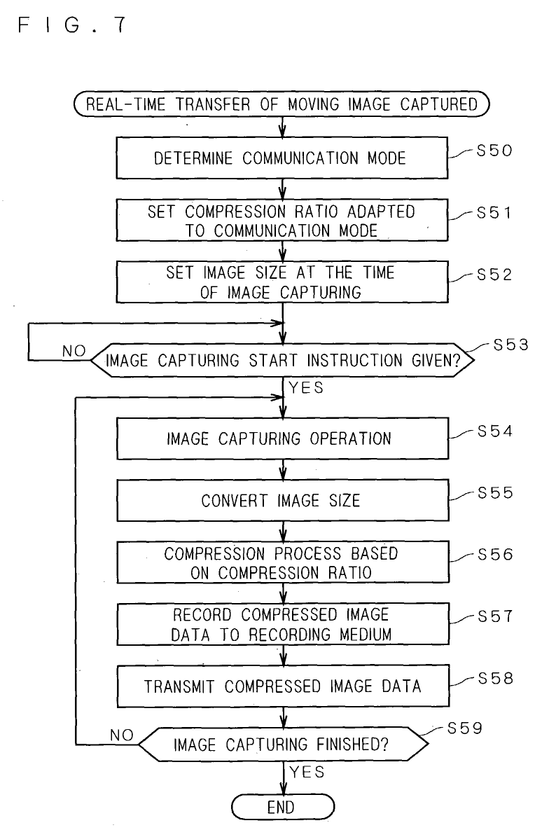

The case of adjusting the compression ratio on the basis of the battery remaining capacity will now be described. FIG. 6 is a flowchart showing an image transfer operation based on the battery remaining capacity. In this case as well, to perform data communication between the digital camera 1 and the external device 2, the user preliminarily performs an operation of connecting a cable or card to any of the connectors in the connector part 3. When an image transfer is instructed in the digital camera 1, the data communication part 30 performs a data communication mode determining process (step S30) and the compression ratio setting part 40 sets the compression ratio corresponding to the data communication mode to the compressor 22 (step S31).

The controller 20 determines whether the digital camera 1 is driven by a battery or an AC adapter (step S32). In the case of driving on a battery, the program advances to step S33. In the case of driving on an AC adapter, the operable time is endless, so that the program advances to step S36.

When the digital camera 1 is driven on a battery, the battery remaining capacity detector 50 functions to detect the remaining capacity of the battery 51 or an external battery (step S33) and to determine whether the battery remaining capacity is smaller than a predetermined value or not (step S34). When the battery remaining capacity is smaller than the predetermined value, the remaining operable time is relatively short. Consequently, to perform efficient data transfer, the program advances to step S35. On the other hand, when the battery remaining capacity is equal to or larger than the predetermined value, it is determined that the remaining operable time is sufficient and the program advances to step S36.

When the battery remaining capacity is determined to be smaller than the predetermined value and the remaining operable time is relatively short, the battery remaining capacity detector 50 transmits a signal indicative of the fact to the compression ratio setting part 40. The compression ratio setting part 40 changes the compression ratio determined in step S31 (compression ratio determined in correspondence with the data communication mode) to a higher value (step S35). By the operation, even in the case where the remaining operable time is relatively short, the amount of image data to be transmitted can be reduced, so that efficient transmission is realized. Since the possibility of completing transmission of image data within the operable time becomes high, reliability of data transmission can be improved.

After that, the data controller 23 in the controller 20 selects one piece of image data to be transmitted from the group of image data pieces recorded on the recording medium 15 (step S36) and reads out the image data from the recording medium 15. When the read image is compressed, the image is decompressed once by the decompressor 24 to the original image (step S37). The data read from the recording medium 15 and decompressed is supplied from the data controller 23 to the compressor 22 where the data is subjected to the compressing process at a compression ratio which is either set on the basis of the data communication mode or changed on the basis of the battery remaining capacity (step S38). The image data compressed by the compressor 22 is supplied to the data communication part 30 and sent to the external device 2 (step S39).

Whether transfer of all of the image data pieces to be transmitted has been completed or not is determined by the controller 20 (step S40). When image data to be transmitted remains, the processes in steps S36 to S39 are repeated. When transfer of all of image data to be transmitted has been finished, the image transferring process is finished.

By such image transfer, even in the case where the digital camera 1 is driven on the battery and the battery remaining capacity is small, a larger amount of image data to be transmitted can be transmitted.

Although the case of detecting the battery remaining capacity before transfer of the image data is shown in the flowchart of FIG. 6, the present invention is not limited to the case. For example, when the battery remaining capacity becomes smaller than the predetermined value in the flowchart of FIG. 5, an interruption process of changing the present compression ratio to a higher value by one level may be performed.

At the time of changing the compression ratio to a higher value in step S35, it is possible to estimate the remaining operable time (particularly, data communicatable time) from the battery remaining capacity detected in step S33 and to change the compression ratio so that image data can be transmitted within the operable time.

The case of generating image data of a moving image by the image capturing operation and transferring the image data to the external device 2 will now be described.

In the case of capturing a moving image and transmitting the moving image to the external device 2, two modes can be employed: a mode of temporarily recording the image data obtained by the image capturing operation onto the recording medium 15, at the time of transmitting the image data to the external device 2, performing image compression and transmitting the compressed image data; and a mode of concurrently performing the image capturing operation and the transferring operation to transmit a moving image obtained by the image capturing operation in a real-time manner. In the former mode, by performing a transfer process similar to that in the above-described case of a still image, efficient and high-reliability data transfer is realized. In the following, the details of the latter mode, that is, the operation on moving-image real-time transfer will be described by using two operation sequences.

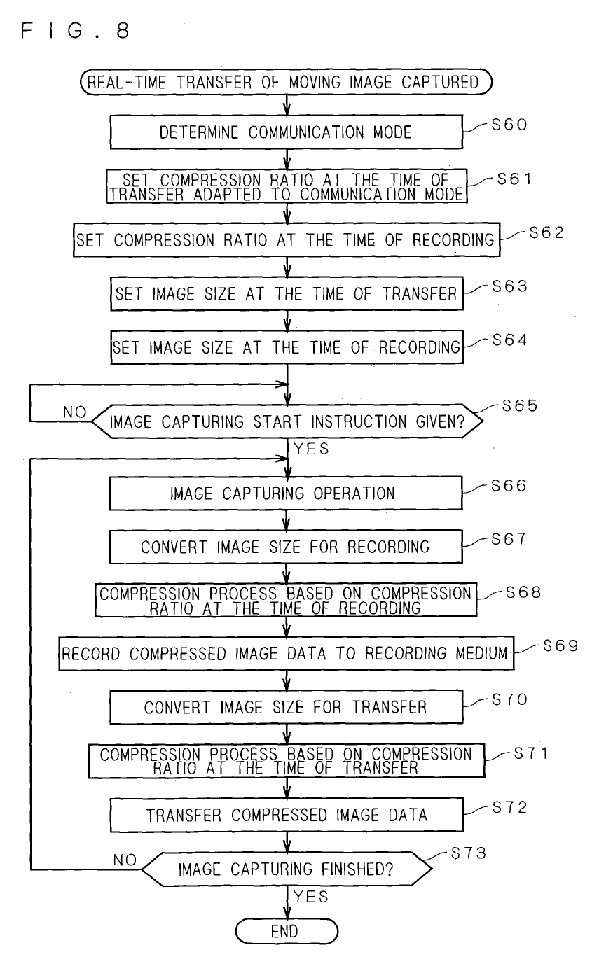

FIG. 7 is a first flowchart regarding real-time transfer of a moving image captured. To concurrently perform the image capturing operation and the real-time transfer of image data obtained by the image capturing operation, the user preliminarily performs the operation of connecting a cable or card to any of the connectors in the connector part 3. To the digital camera 1, the real-time transmission mode of concurrently performing the moving image capturing operation and image data transmitting operation is set. By the operation, the moving image real-time transmitting process is started.

In the digital camera 1, the data communication part 30 performs the process of determining the data communication mode (step S50), and the compression ratio setting part 40 sets the compression ratio corresponding to the data communication mode to the compressor 22 (step S51).

The controller 20 sets the size of image data to be generated at the time of image capturing (step S52). At this time, the image size is set on the basis of the data communication mode determined in step S50. For example, when the transfer speed between the digital camera 1 and the external device 2 is relatively low (concretely, when it is lower than a predetermined speed value), to enable the image data to be efficiently transferred, the image size is set to a small size. On the other hand, when the transfer speed between the digital camera 1 and the external device 2 is relatively high (concretely, when it is higher than the predetermined speed value), to enable high-definition image data to be transferred, the image size is set to a large size.

By determining the image size at the time of image capturing in accordance with the data communication mode, the amount of image data to be transmitted can be adjusted not only by adjusting the compression ratio of the compressing process but also by adjusting the image size.

Whether the moving image capturing start instruction has been given by operating the operation part 18 such as a shutter release button by the user or not is determined (step S53). When the image capturing start instruction is given, the program advances to step S54 where the moving image capturing operation is started.

When the image capturing start instruction is given, the controller 20 controls to repeatedly perform the photoelectric conversion in the CCD image capturing device 11 and starts the moving image capturing operation so that continuous image data is sequentially inputted to the controller 20 (step S54).

The image data sequentially inputted to the controller 20 is converted to the image size set in step S52 in the image processor 21 (step S55) and the resultant data is supplied to the compressor 22. The compressor 22 performs the compressing process on the size-converted image data (step S56). In the compressor 22, the compressing process based on the compression ratio set in step S51 is performed. The image data compressed in the compressor 22 is supplied to the data controller 23 and the data communication part 30. The data controller 23 records the compressed image data to the recording medium 15 (step S57) and the data communication part 30 transmits the compressed image data to the external device 2 (step S58).

The controller 20 repeatedly executes the processes in steps S54 to S58 on the image data of the moving image until an image capturing end instruction is given (step S59).

In the moving-image real-time transmission shown in FIG. 7, image data obtained by the image capturing operation is transmitted in a real-time manner to the external device 2 and image data of a moving image is recorded to the recording medium 15. Consequently, even if a communication error occurs in the real-time transmission and all of data constructing a moving image cannot transmitted, the image data recorded on the recording medium 15 can be transmitted later.

Since the same image data as the image data transmitted in a real-time manner is recorded on the recording medium 15, only by performing each of image size conversion in the image processor 21 and the compressing process in the compressor 22 once, both image data for recording and image data for transfer can be generated. Thus, the efficient process can be achieved.

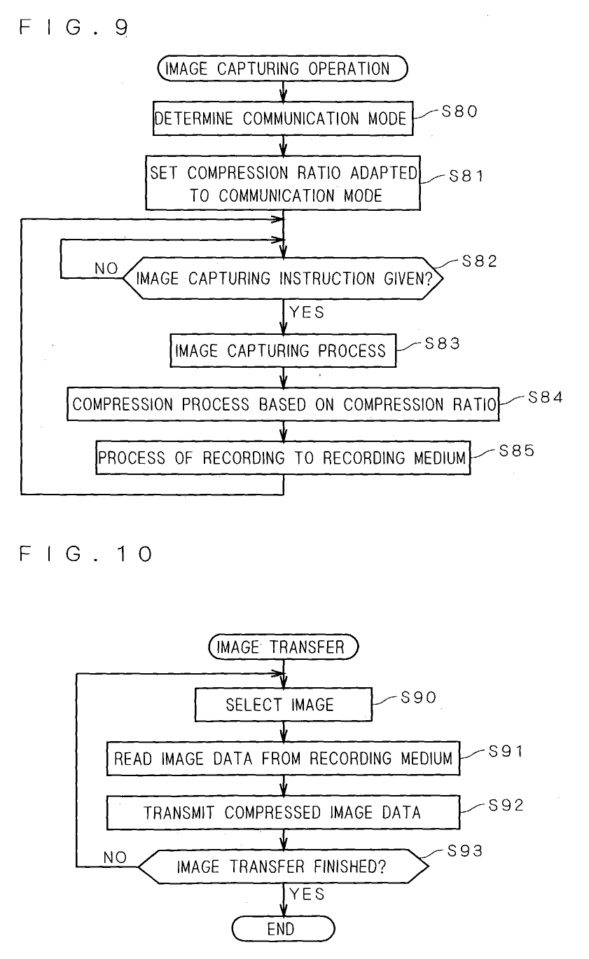

FIG. 8 is a second flowchart regarding a real-time transfer of a moving image captured. To concurrently perform the image capturing operation and the real-time transfer of image data obtained by the image capturing operation, in a manner similar to the above, the user preliminarily performs an operation of connecting a cable or card to any of the connectors in the connector part 3. In a manner similar to the above, the real-time transmission mode of concurrently performing the moving image capturing operation and the image data transmitting operation is set in the digital camera 1. By the above, the moving-image real-time transmitting process is started.

In the digital camera 1, the data communication part 30 performs the process of determining the data communication mode (step S60), and the compression ratio setting part 40 sets the compression ratio at the time of data transfer corresponding to the data communication mode to the compressor 22 (step S61). The compression ratio setting part 40 sets the compression ratio at the time of recording to the compressor 22 (step S62). The compression ratio at the time of recording is set to be lower than that at the time of data transfer so that high-definition image data is recorded on the recording medium 15.

In the controller 20, based on the data communication mode determined in the communication mode determining part 32, the image size at the time of data transfer is set (step S63) and the image size at the time of recording is set (step S64). The image size at the time of recording is set to a size larger than the image size at the time of data transfer so that high-definition image data is recorded on the recording medium 15.

Whether the moving image capturing start instruction has been given or not by operating the operation part 18 such as the shutter release button by the user is determined (step S65). When the image capturing start instruction is given, the program advances to step S66 where the moving image capturing operation is started.

When the image capturing start instruction is given, the controller 20 controls to repeatedly perform the photoelectric conversion in the CCD image capturing device 11 and starts the moving image capturing operation so that continuous image data is sequentially inputted to the controller 20 (step S66).

In the controller 20, first, the process of recording image data to the recording medium 15 (steps S67 to S69) is performed and, after that, the process of transferring the image data to the external device 2 (steps S70 to S72) is performed.

The image data sequentially inputted to the controller 20 is converted to the image size set in step S64 in the image processor 21 (step S67) and the resultant data is supplied to the compressor 22. The compressor 22 performs the compressing process based on the compression ratio set in step S62 on the size-converted image data (step S68). The image data compressed by the compressor 22 is supplied to the data controller 23 and the compressed image data is recorded on the recording medium 15 (step S69).

The image data sequentially inputted to the controller 20 is converted to the image size set in step S63 in the image processor 21 (step S70) and is supplied to the compressor 22. The compressor 22 performs the compressing process based on the compression ratio set in step S61 on the size-converted image data (step S71). The image data compressed by the compressor 22 is supplied to the data communication part 30 and the compressed image data is transmitted to the external device 2 (step S72).

The controller 20 repeatedly executes the processes in steps S66 to S72 on the image data of the moving image until an image capturing end instruction is given (step S73).

Also in the moving-image real-time transmission shown in FIG. 8, image data obtained by the image capturing operation is transmitted in a real-time manner to the external device 2 and image data of a moving image is recorded onto the recording medium 15. Consequently, even when a communication error occurs in the real-time transmission and all of data constructing a moving image cannot transmitted, the image data recorded on the recording medium 15 can be transmitted later.

Since image data of higher quality than the image data transmitted in a real-time manner is recorded on the recording medium 15, in the case where the external device 2 uses the image data of higher quality than the image data received from the digital camera 1, the image data recorded on the recording medium 15 can be used. Also at the time of transmitting image data to another external device in a data communication mode which is different from the mode at the time of the real-time transmission, image data of the amount optimum to the data communication mode can be generated.

2. Second Embodiment

The first embodiment has been described with respect to the mode in which in the case of temporarily recording image data on the recording medium 15 and, after that, transmitting the image data to the external device 2, image data compressed at a low compression ratio or uncompressed image data is recorded on the recording medium 15.

However, also in the case where image data is temporarily recorded on the recording medium 15 and, after that, transmitted to the external device 2, by compressing image data at a compression ratio corresponding to the data communication mode at the time of recording the image data to the recording medium 15, it is unnecessary to perform the compressing process upon transmission and the process efficiency at the time of transmission is improved.

In the second embodiment, a mode of generating image data at a compression ratio corresponding to a data communication mode at the time of recording image data onto the recording medium 15 and recording the image data onto the recording medium 15 will be described. In the second embodiment as well, the internal configuration of the digital camera 1 is similar to that shown in FIG. 3. However, the decompressor 24 is unnecessary.

FIG. 9 is a flowchart showing the image capturing operation in the digital camera 1. When the digital camera 1 is set in the image capturing mode, the data communication part 30 performs the data communication mode determining process (step S80), and the compression ratio setting part 40 sets the compression ratio corresponding to the data communication mode to the compressor 22 (step S81). In the case where a communication cable or communication card is not connected to the connector part 3 in the image capturing mode, a predetermined default value is set as the compression ratio.

By determining whether or not the shutter release button depressing operation was performed by the user, the controller 20 determines whether the image capturing instruction has been given or not (step S82). When the image capturing instruction has been given, the controller 20 starts the image capturing process (step S83). Image data obtained by the A/D converter 13 is supplied to the controller 20 and is subjected to the compressing process at the compression ratio set in step S81 (step S84). In the case where a communication cable or communication card is preliminarily inserted to the connector part 3, image data of an optimum data amount corresponding to the data communication mode established between the digital camera 1 and the external device 2 is generated by the compressing process. The image data is supplied to the data controller 23 and recorded onto the recording medium 15 (step S85).

In the case where the data communication mode is specified at the time of image capturing, the image data of the data amount optimum to the data communication mode is recorded on the recording medium 15. When the image capturing instruction is given, the image capturing operation in steps S82 to S85 is repeated. Image data obtained by the image capturing operation is sequentially recorded in a compressed state corresponding to the data communication mode onto the recording medium 15.

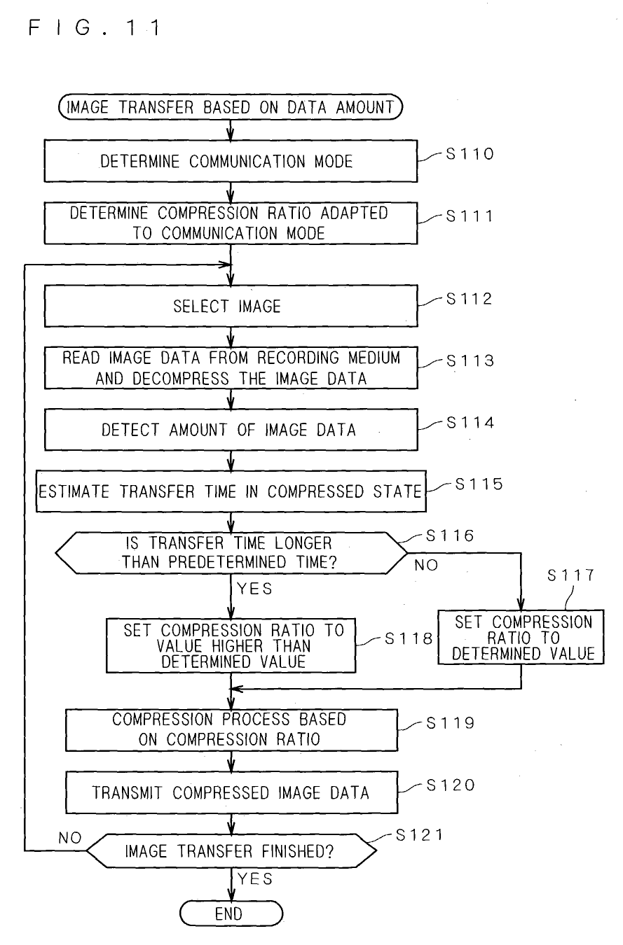

FIG. 10 is a flowchart showing an image transferring operation at the time of transmitting image data recorded on the recording medium 15 to the external device 2. When an image transfer is instructed in the digital camera 1, the data controller 23 in the controller 20 selects one piece of image data to be transmitted from a group of image data pieces recorded on the recording medium 15 (step S90) and reads out the selected image data from the recording medium 15 (step S91). Since the image data compressed in correspondence with the data communication mode is recorded on the recording medium 15, the image data read in step S91 is compressed image data. The compressed image data read out from the recording medium 15 is supplied from the data controller 23 to the data communication part 30 and transmitted to the external device 2 (step S92).

Whether transfer of all of the image data to be transmitted has been completed or not is determined in the controller 20 (step S93). When image data to be transmitted still remains, the processes in steps S90 to S92 are repeated. When the transfer of all of image data to be transmitted is completed, the image transferring process is finished.

Also in the case where it is constructed to preliminarily compress image data at the compression ratio corresponding to the data communication mode at the time of recording (capturing) an image, in a manner similar to the first embodiment, image data can be transmitted to the external device efficiently, and reliability of data transmission can be improved. As in the second embodiment, by preliminarily compressing image data at the compression ratio corresponding to the data communication mode, recording the compressed image data, and transmitting the recorded image data to the external device 2 at the time of transmission, it is unnecessary to perform the compressing process at the time of transmission of image data and more efficient data transmission can be performed.

Also in the second embodiment, as described in the first embodiment, the compression ratio may be adjusted on the basis of the battery remaining capacity.

3. Third Embodiment

In each of the foregoing embodiments, the case where image data compressing process is performed on the basis of the compression ratio determined in correspondence with the data communication mode irrespective of the amount of image data which is not yet compressed has been described mainly. In practice, in many cases, the amount of image data which is not yet compressed varies according to a setting of resolution or the like at the time of image capturing.

Consequently, in a third embodiment, a configuration for adjusting a compression ratio determined according to the data communication mode for each image by detecting the amount of image data recorded on the recording medium 15 will be described.

In the third embodiment as well, the internal configuration of the digital camera 1 is similar to that shown in FIG. 3. In the third embodiment, however, the data controller 23 in the controller 20 has the function of detecting the amount of image data recorded on the recording medium 15. In the following description of the procedure, the case of temporarily recording image data onto the recording medium 15 by the image capturing operation and, after that, transmitting the image data to the external device 2 will be described.

The image capturing operation is similar to that of the flowchart of FIG. 4, and image data obtained by the image capturing is recorded on the recording medium 15.

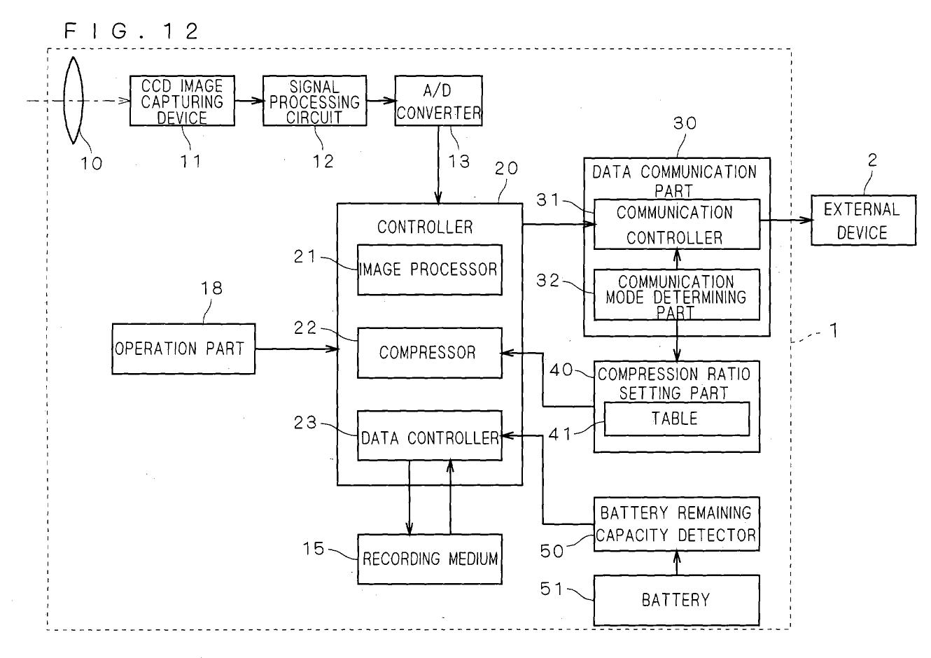

FIG. 11 is a flowchart showing an image transferring operation based on a data amount. First, to perform data communication between the digital camera 1 and the external device 2, the user preliminarily performs an operation of connecting a cable or card to any of the connectors in the connector part 3. When an image transfer is instructed in the digital camera 1, the data communication part 30 performs a data communication mode determining process (step S110) and, with reference to the table 41, the compression ratio setting part 40 sets the compression ratio corresponding to the data communication mode to the compressor 22 (step S11).

The data controller 23 in the controller 20 selects one piece of image data to be transmitted from the group of image data pieces recorded on the recording medium 15 (step S112), reads out the image data from the recording medium 15 and decompresses the read image data according to the resolution which is set at the time of image capturing (step S113). The data controller 23 detects the amount of image data to be transmitted (step S114). The amount of each image data piece can be detected by data recorded in the header portion corresponding to the image data.

The controller 20 estimates transfer time in a data compressed state by performing transfer time estimating computation (step S115). Concretely, the data amount in the case of compressing the amount of image data to be transmitted at the compression ratio determined in step S111 is obtained by computation and, on the basis of the obtained data amount and a data communication amount per unit time between the digital camera 1 and the external device 2, the transfer time in the compressed state is estimated.

The controller 20 determines whether the estimated transfer time is longer than predetermined time or not (step S116). When the estimated transfer time is longer, the controller 20 determines that efficient data transfer cannot be performed and changes the compression ratio to a compression ratio higher than that determined in step S111 (step S118). On the other hand, when the estimated transfer time is shorter than the predetermine time, the controller 20 determines that efficient data transfer can be performed and sets the compression ratio determined in step S111 for an actual compressing process (step S117).

The image data is supplied to the compressor 22 and is subjected to the compressing process at the compression ratio set in step S117 or S118 (step S119). The image data compressed in the compressor 22 is given to the data communication part 30 and transmitted to the external device 2 (step S120).

Whether image transfer has been completed or not with respect to all of image data to be transmitted is determined by the controller 20 (step S121). In the case where image data to be transmitted still remains, the processes in steps S112 to S120 are repeated. In the case where image transfer has been finished with respect to all of the image data to be transmitted, the image transferring process is finished.

By adjusting the compression ratio for each image in accordance with the amount of image data, the optimum data amount according to the data communication mode can be always obtained and data transmission within predetermined time can be stably achieved.

Although the case of temporarily recording image data onto the recording medium 15 by the image capturing operation and transmitting the image data to the external device 2 has been described above, the concept can be applied also to the case of transmitting a moving image in a real time manner without recording the image data onto the recording medium 15.

Also in the third embodiment, as described in the first embodiment, the compression ratio may be adjusted on the basis of the battery remaining capacity.

4. Fourth Embodiment

A fourth embodiment will now be described. In the first embodiment, in the case where the battery remaining capacity becomes small, the compression ratio determined on the basis of the data communication mode is changed to a higher value. When the function of detecting the amount of each image data piece recorded on the recording medium 15 is provided like in the third embodiment, by transmitting the image data in order from the smaller data amount when the battery remaining capacity becomes small, a larger amount of image data can be transmitted to the external device 2 within the remaining operable time.

In the fourth embodiment, therefore, the configuration of detecting the amount of each image data piece recorded on the recording medium 15 and determining the transmission order of the image data on the basis of the data amount of each image data piece will be described.

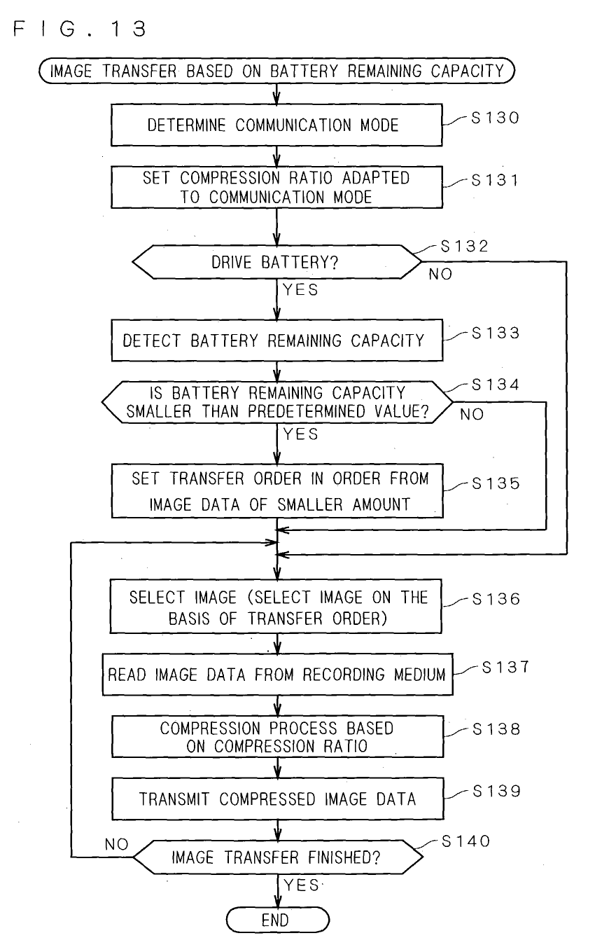

FIG. 12 is a block diagram showing the internal configuration of the digital camera 1 in the fourth embodiment. In FIG. 12, the same reference numerals are designated to components similar to the components shown in FIG. 3. As shown in FIG. 12, the configuration of the digital camera 1 in the fourth embodiment is basically similar to that of FIG. 3 except that when the battery remaining capacity detector 50 detects that the battery remaining capacity becomes smaller than a predetermined value, a signal indicative of the fact is given to the data controller 23.

When the signal indicating that the battery remaining capacity is smaller than a predetermined value is received, the data controller 23 sets the transfer order from the smaller amount of image data at the time of selecting image data from the recording medium 15.

FIG. 13 is a flowchart showing the image transferring operation based on the battery remaining capacity in the embodiment. In this case as well, to perform data communication between the digital camera 1 and the external device 2, the user preliminarily performs the operation of connecting a cable or card to any of the connectors in the connector part 3. When the image transfer is instructed in the digital camera 1, the data communication part 30 performs the data communication mode determining process (step S130). The compression ratio setting part 40 specifies a compression ratio corresponding to the data communication mode by referring to the table 41 and sets the compression ratio to the compressor 22 (step S131).

The controller 20 determines whether the digital camera 1 is driven on the battery or an AC adapter (step S132). In the case of the battery driving, the program advances to step S133. In the case where the digital camera 1 is driven by the AC adapter, the operable time is infinite, so that the program advances to step S136.

When the digital camera 1 is driven on the battery, the battery remaining capacity detector 50 functions to detect the remaining capacity of the battery 51 or an external battery (step S133) and to determine whether the battery remaining capacity is smaller than a predetermined value or not (step S134). When the battery remaining capacity is smaller than the predetermined value, the remaining operable time is relatively short, so that to perform efficient data transfer, the program advances to step S135. On the other hand, when the battery remaining capacity is equal to or larger than the predetermined value, it is determined that the remaining operable time is sufficient and the program advances to step S136.

When it is determined that the battery remaining capacity is smaller than the predetermined value and the remaining operable time is relatively short, the battery remaining capacity detector 50 transmits a signal indicative of the fact to the data controller 23. The data controller 23 accesses the recording medium 15, detects the amount of each image data piece recorded on the recording medium 15, and sets the transfer order from the smaller data amount (step S135). By the operation, even when the remaining operable time is relatively short, the image transfer can be performed by compressing image data in order from a smaller data amount. Thus, efficient transmission can be realized, a larger amount of image data can be transmitted within the operable time, and the reliability of data transmission can be improved.

The program advances to the actual transferring process and the data controller 23 selects image data to be transmitted from a group of image data pieces recorded on the recording medium 15 (step S136). When the transfer order is set in step S135, selection of the image data is performed in accordance with the transfer order. On the other hand, when the transfer order is not set, selection of the image data is performed in an arbitrary order like the order of transmission designation.

The data controller 23 reads out the selected image data from the recording medium 15 (step S137), and the read image data is supplied from the data controller 23 to the compressor 22. The compressor 22 performs the compressing process at the compression ratio set on the basis of the data communication mode (step S138). The image data compressed by the compressor 22 is given to the data communication part 30 and transmitted to the external device 2 (step S139).

The controller 20 determines whether transmission of all of the image data to be transmitted has been finished or not (step S140). When the image data to be transmitted still remains, the processes in steps S136 to S139 are repeated. At this time as well, in step S136, when the transfer order is set, the image data is selected according to the transfer order. When the transfer of all of image data to be transmitted is finished, the image transfer process is finished.

As described above, when the battery remaining capacity in the digital camera 1 becomes small, the compressing process according to the data communication mode is performed in order from a smaller amount of image data and the compressed image data is transmitted to the external device 2, thereby enabling the image data to be transmitted to the external device efficiently within the remaining operable time.

As described in the first embodiment, in the case where the battery remaining capacity becomes small, the transfer order may be determined and the compression ratio may be changed to a higher value.

As described in the third embodiment, it is also possible to compare amounts of decompressed data and set the transfer order from a smaller image data amount.

5. Modifications

Although the embodiments of the present invention have been described above, the present invention is not limited to the above.

Although the case of determining the data communication mode prior to the image transfer and setting the compression ratio has been described above, the present invention is not limited to the case. For example, the communication mode determining part 32 monitors transfer speed at a predetermined timing also during image transfer and, when actual transfer speed fluctuates, the compression ratio may be changed according to the fluctuation. With such a configuration, even when the transfer speed fluctuates during establishment of data communication between the digital camera 1 and the external device 2, the fluctuation is reflected in the compression ratio, and the optimum data communication can be always performed.

Although the case of adjusting the image size in transfer of a moving image has been described above, the adjustment of the image size according to the data communication mode may be also applied to transfer of a still image.

The external device 2 may be a device other than a computer, for example, an image output unit like a printer or an external memory device such as a memory or a magnetic disk drive.

Although the embodiments of the digital camera have been described above, the object to which the present invention is applied is not limited to a digital camera but the concept can be applied to a device as long as the device has a image capturing function of photographing a subject and generating image data.

Further, as the method of determining communication speed, in place of using a “ping” command, data of a predetermined amount is actually sent and communication speed may be determined from the result.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
an image generator for photographing a subject and generating image data;
an interface for performing data communication with an external device;
a discriminator for determining a data communication mode established between said interface and said external device;
a compressor for setting a compression ratio adapted to said data communication mode on the basis of a result of determination of said discriminator and compressing said image data at the set compression ratio; and
a transmitter for transmitting said image data compressed by said compressor to said external device via said interface.

2. The image capturing apparatus according to claim 1, wherein
said discriminator determines communication speed as said data communication mode and said compressor sets a compression ratio in accordance with the determined communication speed.

3. The image capturing apparatus according to claim 2, wherein
said discriminator determines whether the communication speed is high speed or low speed and, when said communication speed is low speed, said compressor sets a higher compression ratio as compared with the case where said communication speed is high speed.

4. The image capturing apparatus according to claim 1, wherein
said discriminator determines wire communication or wireless communication as said data communication mode.

5. The image capturing apparatus according to claim 4, wherein
when said data communication mode is wireless communication, said compressor sets a higher compression ratio as compared with the case where said data communication mode is wire communication.

6. The image capturing apparatus according to claim 1, further comprising:
a recorder for recording image data compressed by said compressor onto a recording medium.

7. The image capturing apparatus according to claim 6, wherein
said compressor sets a compression ratio of image data recorded on said recording medium to a value lower than a compression ratio of image data transmitted by said transmitter.

8. The image capturing apparatus according to claim 6, further comprising:
a detector for detecting an amount of image data recorded on said recording medium, wherein
said compressor sets a compression ratio on the basis of said data communication mode and said data amount.

9. The image capturing apparatus according to claim 8, further comprising:
a calculator for calculating time of transmission of image data to said external device from the data amount detected by said detector, wherein
said compressor sets a compression ratio on the basis of said data communication mode and the transmission time calculated by said calculator.

10. The image capturing apparatus according to claim 6, wherein
said transmitter transmits the compressed image data recorded on said recording medium to said external device.

11. The image capturing apparatus according to claim 6, wherein
image data generated by said image generator can be transmitted as moving image data to said external device via said interface, and
said compressor sets a compression ratio of image data recorded on said recording medium to a value lower than the compression ratio used at the time of transmitting said moving image data.

12. The image capturing apparatus according to claim 1, further comprising:
a converter for converting size of image data generated by said image generator on the basis of a result of determination by said discriminator, wherein
said compressor compresses the image data of which size has been converted by said converter.

13. The image capturing apparatus according to claim 12, further comprising:
a recorder for recording image data compressed by said compressor onto a recording medium, wherein
said converter converts size of image data to be recorded on said recording medium to size larger than size of image data transmitted by said transmitter.

14. The image capturing apparatus according to claim 1, further comprising:
a detector for detecting a remaining capacity of a driving source for driving said image capturing apparatus, wherein
said compressor sets a compression ratio on the basis of said data communication mode and the remaining capacity of said driving source.

15. A method of compressing image data captured by an image capturing apparatus, comprising the steps of:
generating image data;
determining a data communication mode established between an interface for performing data communication and an external device;
setting a compression ratio adapted to the determined data communication mode;
compressing said image data at the set compression ratio; and
transmitting the compressed image data to said external device via said interface.

16. An image capturing apparatus comprising:
an image generator for photographing a subject and generating image data;
an interface for performing data communication with an external device;
a detector for detecting a remaining capacity of a driving source for driving said image capturing apparatus;
a compressor for setting a compression ratio on the basis of the remaining capacity of said driving source detected by said detector and compressing said image data at the set compression ratio; and
a transmitter for transmitting said image data compressed by said compressor to said external device via said interface.

17. The image capturing apparatus according to claim 16, wherein
when the remaining capacity of said driving source becomes smaller than a predetermined amount, said compressor sets a compression ratio to a higher value as compared with the case where the remaining capacity of said driving source is larger than the predetermined amount.

18. A method of compressing image data captured by an image capturing apparatus, comprising the steps of:
generating image data;
detecting a remaining capacity of a driving source for driving said image capturing apparatus;
setting a compression ratio on the basis of said detected remaining capacity of said driving source and compressing said image data at the set compression ratio; and
transmitting the compressed image data to an external device via said interface.

19. An image capturing apparatus comprising:
an image generator for photographing a subject and generating image data;
a recorder for recording the image data generated by said image generator onto a recording medium;
a first detector for detecting an amount of the image data recorded on said recording medium;
a second detector for detecting a remaining capacity of a driving source for driving said image capturing apparatus;
an interface for performing data communication with an external device;
a reader, when the remaining capacity of said driving source detected by said second detector becomes smaller than a predetermined amount, for reading image data from said recording medium in order from image data of a smaller amount on the basis of a result of detection performed by said first detector; and
a transmitter for transmitting said image data read by said reader to said external device via said interface.

20. A method of transmitting image data captured by an image capturing apparatus, comprising the steps of:
generating image data;
recording the generated image data onto a recording medium;
detecting an amount of the image data recorded on said recording medium;
detecting a remaining capacity of a driving source for driving said image capturing apparatus;
reading the image data from said recording medium in order from a smaller amount of image data in said detected data amount, when the remaining capacity of said driving source becomes smaller than a predetermined amount; and
transmitting the read image data to an external device via an interface.
